(19) United States
(12) Patent Application Publication
(10) Pub. No.: US 2006/0245712 A1
(43) Pub. Date: Nov. 2, 2006

(54) Devices, systems and methods for testing optoelectronic modules

(76) Inventors: Alexander Fishman, Sunnyvale, CA (US); Peter A. Scranton, Hayward, CA (US); John C. Dirkson, Santa Clara, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/117,784

(22) Filed: Apr. 29, 2005

(51) Int. Cl. G02B 6/00

(52) U.S. Cl. 385/134

(57) ABSTRACT

Embodiments of the present invention provide devices, systems and methods to test optoelectronic modules. In one embodiment, the testing device can include a printed circuit board (PCB) and a first portion attached to the PCB. A second portion can be attached to the first portion. The second portion can include at least one testing device that can be used to test an optoelectronic module disposed between the first portion and the second portion. The optoelectronic module can be electrically and mechanically connected to at least one of the PCB and the first portion. Additionally, in some embodiments, the at least one testing device can be electrically connected to an electrical circuit or host device that is external to the apparatus

### BACKGROUND OF THE INVENTION

1. The Field of the Invention

Embodiments of the present invention relate to the field of testing devices and, more specifically, to testing devices for use with various types of optoelectronic modules.

2. The Relevant Technology

Optoelectronic modules are commonly employed in fiber optic data transmission networks in the transmission and receipt of binary data signals. One such optoelectronic module is an optoelectronic transceiver module that can include, among other things, an optical transmitter, such as a laser, that receives electrical data signals, translates the electrical data signals to optical data signals, and then transmits the optical data signals. Further, the optoelectronic transceiver can also include an optical receiver, such as a photodiode, which receives optical data signals, translates the optical data signals to electrical data signals, and then transmits the electrical data signals. Optoelectronic transceivers can also include a printed circuit board (PCB) containing various control circuitry for the optical transmitter and/or optical receiver.

In the manufacture of optoelectronic transceiver modules, each transceiver is tested to ensure that it functions properly. Since optoelectronic transceivers operate in environments characterized by any number of varying conditions, such as temperature and supply voltage for example, the transceivers are typically tested under conditions similar to those likely to be experienced in the intended operating environment.

However, for a number of reasons, testing optoelectronic transceiver modules has proven to be a costly activity. One of the aspects of the optoelectronic module that can be tested is the ability of the module to function over a wide temperature range. Typically, this has been accomplished by attaching the module to a testing board and placing the entire test board and transceiver module combination into an oven for testing over a range of temperatures. This approach to testing has proven problematic because the printed circuit boards used as the testing boards can be very expensive and/or not reliable when operating in the same temperature range as the optoelectronic modules. Therefore, when these boards are heated, they can fail, resulting in increased time and expense to conduct the tests on the modules, as well as time and expense to repair any damage to the test boards. Also, due to the presence of air currents within the oven, precise control of the module temperature is difficult to achieve. Additionally, according to the various different standards used for manufacturing and testing optoelectronic modules, the module temperature must be checked at one or more specific locations on the module's casing. Attaching temperature sensors at the appropriate location by hand can sometimes be very time consuming.

Another problem encountered in module construction and testing is the possibility of an unintentional electrical short between the active electronic components in the module, and the external case. To test for these types of shorts, a known voltage potential can be applied to and measured on the case.

One approach to such problems has been to test the optoelectronic module components individually, and then assemble the module. While such an approach may help to eliminate the problem of determining which particular component is malfunctioning when the module is tested as a whole, such an approach may not provide useful information concerning the performance of the assembled module. The module still must be tested after final assembly to ensure that all connections are working properly. Thus, typical testing evolutions have involved a time consuming, and expensive, two step testing process where the module was tested firstly in the oven at one temperature and then secondly in the oven at a second temperature.

### BRIEF SUMMARY OF THE EMBODIMENTS

Embodiments of the present invention provide a test apparatus comprising a fixed first portion and a second portion connectable to the first portion. In some embodiments, the second portion can be pivotally attached to the first portion. Mounted to the second portion can be at least one testing device that can be used to test an optoelectronic module. Examples of such a testing device can include, but are not limited to, a temperature sensor, a ground test spring, and a thermoelectric cooler. Examples of optoelectronic modules that can be tested with the apparatus can include, but are not limited to, a SFF module, a SFP module, a XFP module, and a GBIC module.

In one embodiment according to the present invention, the testing device can include a printed circuit board (PCB) and a first portion attached to the PCB. A second portion can be attached to the first portion. The second portion can include at least one testing device that can be used to test an optoelectronic module disposed between the first portion and the second portion. The optoelectronic module can be electrically and mechanically connected to at least one of the PCB and the first portion. Additionally, in some embodiments, the at least one testing device can be electrically connected to an electrical circuit or host device that is external to the apparatus. In other embodiments, an electrical probe can be connected to the host device to facilitate additional testing of the optoelectronic module. The testing device can include, by way of example and not limitation, a temperature sensor, a thermal electric cooler (TEC) and a spring test contact.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of one exemplary test apparatus in an open position, according to the present invention;

FIG. 2 illustrates a perspective view of the exemplary test apparatus of FIG. 1 in a closed position;

FIG. 3 illustrates a perspective view of an alternate embodiment of an exemplary test apparatus in an open position, according to the present invention; and

FIG. 4 illustrates a perspective view of the exemplary test apparatus of FIG. 3 in a closed position.

### DETAILED DESCRIPTION OF THE EMBODIMENTS

Embodiments of the present invention provide a test apparatus comprising a fixed first portion and a second portion connectable to the first portion. In some embodiments, the second portion can be pivotally attached to the first portion. Mounted to the second portion can be at least one testing device that can be used to test an optoelectronic module. Examples of such a testing device can include, but are not limited to, a temperature sensor, a spring test contact, and a thermoelectric cooler. Examples of optoelectronic modules that can be tested with the apparatus can include, but are not limited to, a SFF module, a SFP module, a XFP module, and a GBIC module.

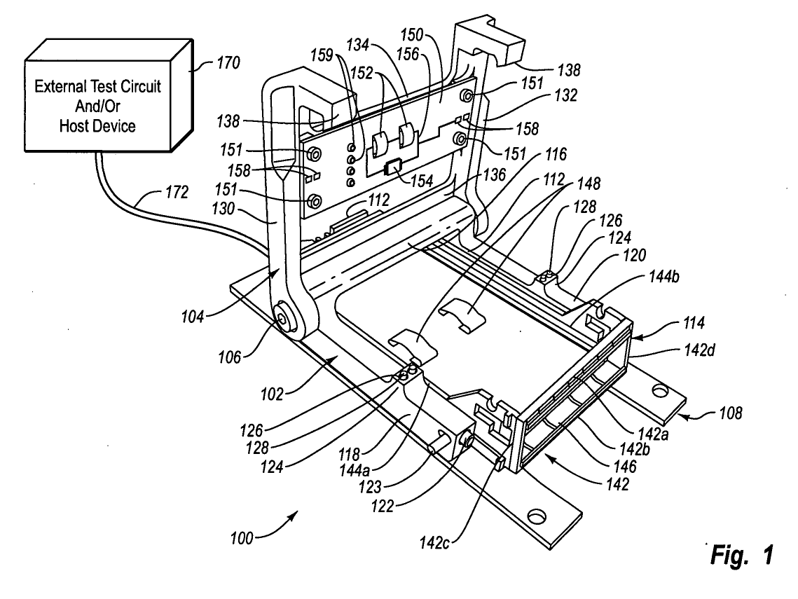

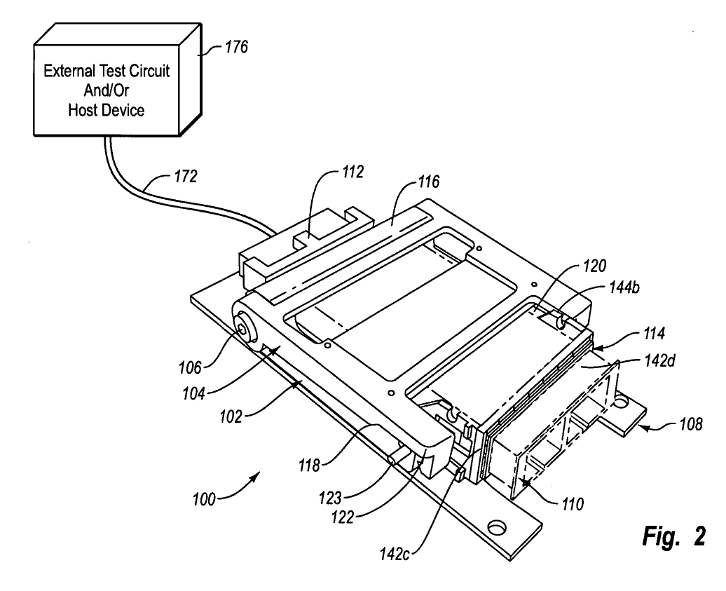

One embodiment of a test apparatus is shown in FIGS. 1 and 2, and is designated generally as reference numeral 100. Apparatus 100 can include a first portion or base 102. A second portion or top 104 can be connected to first portion 102. In some embodiments, second portion 104 can be pivotally connected to first portion 102 at a pivot point 106. It is understood that the terms “top” and “base” are used with reference to the specific orientation shown in the Figures. In other orientations, the terms could be reversed, or first portion 102 and second portion 104 could be placed side-by-side. The specific spatial references are provided for convenience in description, and should not be construed as limiting the embodiments of the present invention in any way.

In some embodiments, base 102 can be attached to a stabilizing platform 108. Platform 108 can be a printed circuit board (PCB) that contains electrical circuitry to connect a device under test (DUT) 110 (illustrated in phantom in FIG. 2) to external test circuitry or a host device 170. In the embodiments illustrated in FIGS. 1 and 2, DUT 110 can be mechanically and electrically connected to an interface 112 that is electrically and mechanically attached to platform 108. In alternate embodiments, interface 112 can be connected to base 102. A guide member 114 can be attached to base 102 to assist an operator in connecting DUT 110 to apparatus 100. Specific details of the construction of apparatus 100 are discussed herein after.

In the embodiment illustrated in FIGS. 1 and 2, base 102 can include a cross piece 116 between left and right side braces 118, 120, respectively. As with the terms “top” and “bottom”, the terms “left” and “right” are descriptive of the orientation shown in FIGS. 1 and 2, and should not be construed to limit the embodiments of the invention in any way. The cross piece 116 can be an integrated part of side braces 118, 120, thus forming the base 102 as a single unit. Alternately, cross piece 116 can be attached to side braces 118, 120 using chemical and/or mechanical fasteners. One or both of the left and right side braces 118, 120 can also include a catch 122, which will be discussed in more detail below.

Base 102 can also include one or more elevated portions 124. In the embodiment illustrated in FIGS. 1 and 2, base 102 includes an elevated portion 124 on each of side braces 118 and 120. The elevated portion(s) 124 can be an integral part of left and right braces 118, 120. Alternately, the elevated portions 124 can be separately attached to left and right braces 118, 120. Each elevated portion 124 can include one or more spring loaded-member or pogos 126. Each pogo 126 can include a pin 128 that can form an electrical connection between platform 108 and a PCB 150 containing various testing circuitry that is mounted on top portion 104. This will be discussed in more detail below.

The top portion 104 can include left and right side rails 130, 132 respectively, connected by one or more cross braces. In the embodiment shown in FIGS. 1 and 2, left and right side rails 130, 132 are connected by front and rear cross braces 134, 136, respectively. Additionally, a hook 138 can be included on a front portion of one or both left and right side rails 130, 132. The hook 138 can be configured to engage with catch 122 during testing of DUT 110. A release lever 123 can be provided in left and right side braces 118, 120 to retract catch 122 and release hook 138. Other methods of releasing catch 122 are also possible. For instance, it can be understood that in alternate embodiments only one of the left and right braces 118, 120 includes a catch 122 and release hook 138 and so only one of side rails 130, 132 includes hook 138. Likewise, in some alternate embodiments, catch 122 can be fixed to base 102, while hook 138 is pivotally connected to top portion 104. In this embodiment, when top portion 104 is lowered, hook 138 can be rotated to engage catch 122, thus securing top portion 104 to base 102.

Also connected to top portion 104 is PCB 150. In this embodiment, PCB 150 is removably attached to front cross brace 134, using, by way of example and not limitation, one or more mechanical fasteners 151, or any other type of fastener that allows PCB 150 to be easily attached and removed from top portion 104. Specific details concerning board 150 will be discussed below.

In this embodiment, platform 108 can be any rigid structure that provides sufficient support for apparatus 100. Examples of such materials include, but are not limited to, plastics of various types, glass, ceramics, composites, or any other material that provides sufficient structural support. In some embodiments, platform 108 can be a printed circuit board that includes electrical components, traces, and connections that can be used in the testing process.

Base 102 and top 104 can comprise metal, plastic, composites, or any other materials that provide sufficient structural rigidity to hold DUT 110 in a fixed position while testing is performed. Specific details concerning the materials and structure of base 102 and top 104 are provided for the purposes of illustration only. Other structures and materials are also possible, and fall within the scope of the embodiments of the invention.

In the embodiment illustrated in FIGS. 1 and 2, guide member 114 is located inside of base 102 and connected to platform 108. The guide member 114 can include a face portion 142 that comprises upper and lower guide rails 142a and 142b, respectively, as well as a left and right brace 142c, 142d, respectively. The guide member 114 can also include a left and right side rail 144a, 144b, respectively, extending towards a rear of apparatus 100. Additionally, guide member 114 can include one or more metallic strips 146 that facilitate electromagnetic interference (EMI) isolation of a casing of DUT 110.

In this embodiment, guide member 114 is designed to facilitate the positioning of a GBIC module as DUT 110. The guide member 114 allows a GBIC module to slide into apparatus 100 such that the electrical connectors on a rear of the GBIC electrically and mechanically connect to interface 112. In some embodiments, an industry standard GBIC guide member 114 can be used. However, other modules, electronic, or optoelectronic devices can also be tested using specific embodiments of the invention. Such modules can include, by way of example and not limitation, SFF, SFP, and XFP modules. In some embodiments, an industry standard SFP and XFP guide member can be used. Alternately, a specific design for these guide members, and/or the SFF guide member, can be adopted notwithstanding any industry standard. Any structure designed to guide movement of a DUT within apparatus 100 is contemplated to fall within the scope of the embodiments. Alternately, other similar guide structures can be included with or integrated into top 104 or base 102.

While, in this embodiment, guide member 114 is a cage-like structure designed to position DUT 110 within apparatus 100, other structures, including, but not limited to, guide rails, guide slots, lateral and/or rear pins, lateral and/or rear posts, and lateral and/or rear stops, can also be used. The guide member 114 can be sized and configured to guide a specific type of module. Likewise, in this embodiment, guide member 114 comprises plastic. However, other materials including, but not limited to, metals, ceramics, composites, etc., can also be used.

With continued reference to FIG. 1, platform 108 can include a pair of spring contacts 148. Spring contacts 148 are designed to provide a way to measure the electrical potential across a metal casing of DUT 110. The base 108 can also include additional electrical circuitry that can be useful in the testing process. Alternately, spring contacts 148 and additional electrical circuitry can be part of PCB 150 that is attached to top portion 104. The specific size and/or location of spring contacts 148 on platform 108 can vary depending on the type of module to be tested.

The PCB 150 can be designed to test specific types of modules. In one embodiment, PCB 150 can include one or more testing devices such as but not limited to, (i) one or more short circuit testing devices 152 to ensure that the case is electrically isolated from the internal module components, (ii) one or more temperature sensors 154 that measure a temperature of DUT 110 at a specific point, and (iii) additional testing circuitry 156. The additional testing circuitry 156 can include one or more electrical pads 158 that provide an electrical connection between PCB 150 and pins 128 in pogos 126. In addition to the testing circuitry on PCB 150, other testing circuitry can include one or more electrical probes 159 mounted on PCB 150. Probe(s) 159 can be used, by way of example and not limitation, if DUT 110 does not have a top cover. Probe(s) 159 can be used, again by way of example and not limitation, to test the electrical properties of one or more subassemblies in DUT 110, for choosing proper values for the DC/AC bias resistors, for programming microcontrollers, and for performing other electrical testing and/or pre-shipment setup of DUT 100.

Additionally, one or more thermal electric coolers (TEC, not shown) can be used to cool, heat, and test DUT 110 at different temperatures without subjecting the entire testing apparatus to the temperature extremes experienced when putting the entire apparatus in an oven for temperature testing. The TEC can be part of PCB 150, or a separate component that is attached to arm 134. The use of a TEC as the testing device allows for testing to be done at multiple temperatures over various temperature ranges. This testing can be accomplished quickly and easily, since the TEC efficiently raises or lowers the module temperature to a desired level much quicker that ambient air circulating in an oven.

In one embodiment, PCB 150 uses a pair of short circuit testing devices 152 to electrically test the casing of DUT 110. In this embodiment, short circuit testing devices 152 take the form of a pair of metallic springs, although other similar structures can be used. For example, one spring can be connected to a positive terminal of a power supply through a first adjustable resistor, while the other spring can be connected to a negative terminal of the power supply through a second adjustable resistor. When short circuit testing devices 152 contact the case of DUT 110 (made of a conductive material), the expected divider output voltage can be measured to verify that no foreign voltage exists on the case.

One problem with making this measurement is that it must be done over a range from 0 volts to a maximum DUT power supply voltage. This is because, under certain circumstances, it is possible for a short to exist that is not “caught” when using fixed resistors. For example, if a test voltage of about 1.5 volts is used, and the DUT 110 has a short circuit to a component that carries about 1.5 volts, this short circuit would not be noticed. The test would measure the expected value of 1.5 volts even though a short was present.

One way to overcome this problem is to use a variable resistor and test over a range of voltages. For example, in one embodiment, the tester can sweep the divider output voltage by changing the adjustable resistor values and measuring the expected voltages across the casing. This method can bring the probability of foreign voltage escapes to zero.

In another embodiment, PCB 150 can include temperature sensor 154. The temperature sensor 154 can be located on PCB 150 such that, when top 104 is lowered to engage DUT 110, sensor 154 contacts a point on the casing of DUT 110 that corresponds with a desired temperature testing point. Various standards setting organizations provide specific areas on the external casing where temperature testing is required to be done. These external points may, although they need not, correspond to the point on the casing above the laser transmitter in the DUT 110. This point is often the hottest part of the casing. This temperature measurement is used to determine if the DUT 110 is operating within acceptable operational parameters. For example, there is a Multisource Agreement (MSA) standard for SFF, SFP, XFP, GBIC, etc., modules that determines the specific testing point and the temperature range for normal operation of the module. Therefore, the specific location of temperature sensor 154 on PCB 150 and also the location of PCB 150 on top 104 can vary depending on the specific type of module to be tested. For example, in the embodiment illustrated in FIGS. 1 and 2, temperature sensor 154 is located towards the rear of circuit board 150.

The board 150 can be electrically connected to additional testing circuitry or an external host device, shown generally as reference numeral 170 in FIGS. 1 and 2. One or more electrical connections 172 can connect the external device 170 to the test apparatus 100. In the embodiment illustrated in FIGS. 1 and 2, PCB 150 can be electrically connected to these external devices using one or more pins 128 mounted in one or more pogos 126 that are mounted on one or more elevated portions 124 of each side brace 118 and 120, as previously discussed. In other embodiments, the electrical connections between PCB 150 and any external devices could be made by routing wires through, or attaching wires to, rails 130, 132. Those skilled in the art will realize that there are many ways to make the appropriate electrical connections. The embodiments of the present invention illustrated in FIGS. 1 and 2 are illustrative only, and should not be construed to limit the invention in any way.

In operation, catch 122 can mate with hook 138 on the ends of corresponding left and right rails 130, 132, respectively. In the embodiment shown in FIGS. 1 and 2, hooks 138 are fixed to left and right arms 130, 132. The catch 122 can be biased in an outward position using, by way of example and not limitation, a spring or other biasing device (not shown). When top portion 104 is lowered onto DUT 110, hook 138 engages catch 122, thus holding DUT 110 in a fixed position. A release lever 123, or other release mechanism, can be included to allow hook 138 to be released as catch 122 is withdrawn into the respective side braces 118 and 120.

Apparatus 100 allows for the testing of many different types of modules by using a specific PCB 150 and platform 108, having various components, such as temperature sensor 154, located at different positions for each DUT 110 to be tested. The PCBs 150 can have different thicknesses and/or be biased in a downward direction to facilitate adequate contact between, for example, temperature sensor 154 and the casing of DUT 110. This biasing can be accomplished, by way of example and not limitation, by placing one or more springs or other biasing mechanism (not shown) between a back side of PCB 150 and arm 134. This biasing mechanism, in conjunction with mechanical fasteners 151 can be designed and positioned to allow PCB 150 to adjust to the position of DUT 110 when top portion 104 is lowered. These springs can then press PCB 150 relatively flush onto DUT 110 when top portion 104 is lowered.

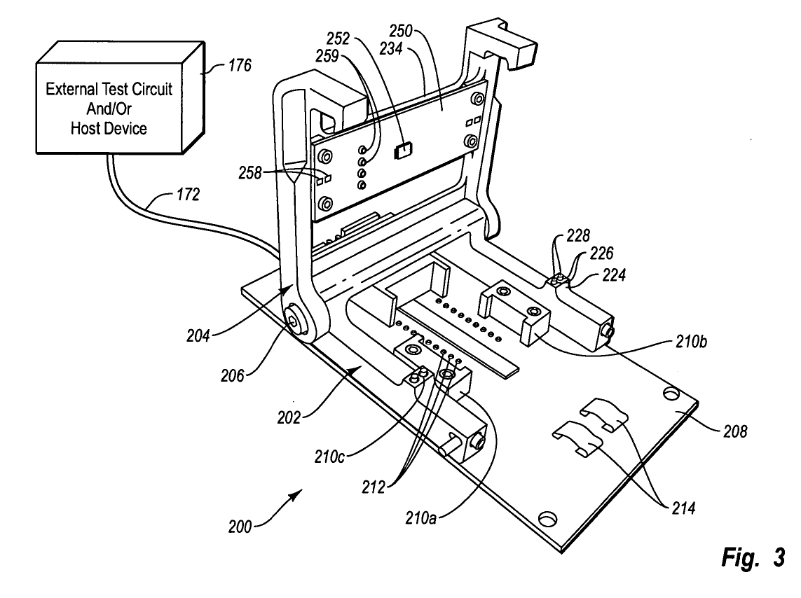

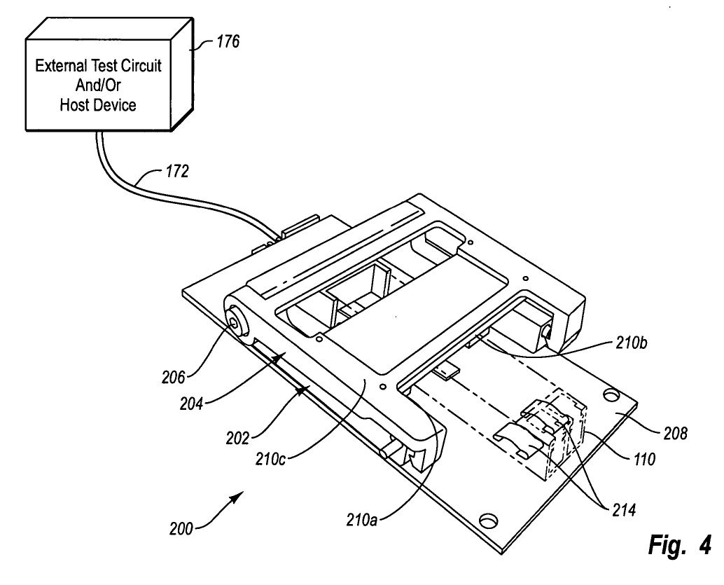

An alternate embodiment of the apparatus of the present invention is illustrated in FIGS. 3 and 4, and designated generally as reference numeral 200. Apparatus 200 can include a first portion or base 202. A second portion or top 204 can Be connected to first portion 202. In some embodiments, second portion 204 can be pivotally connected to first portion 202 at a pivot point 206. The base 202 can be attached to a stabilizing platform 208. Platform 208 can be a printed circuit board (PCB) that contains electrical circuitry to connect DUT 110 (illustrated in phantom in FIG. 4) to external test circuitry or host device 170. The basic design and materials used in apparatus 200 can be identical to that of apparatus 100, discussed above. For example, the basic design details and materials used in base 202 and top 204 that form part of apparatus 200 can be the same as discussed above with respect to base 102 and top 104. However, the embodiment illustrated in FIGS. 3 and 4 is specifically designed to test an SFF module as DUT 110.

As previously discussed, apparatus 200 can include different versions of platform 208 and a PCB 250 attached to top 204 that are specifically tailored to provide testing for various types of optoelectronic modules. In this embodiment, platform 208 can include a left and right guide member 210a and 210b, respectively, and a rear guide member 210c, that facilitate the alignment of an SFF module 110 (shown in phantom in FIG. 4) with platform 208. Platform 208 can also include a plurality of electrical receptacles 212 that are designed to interface with corresponding pins (not shown) on the SFF module. By aligning the SFF module with guide members 210a, 210b and 210c, the SFF module can easily be connected to platform 208 using electrical receptacles 212. Additionally, platform 208 can include a pair of spring contacts 214. Spring contacts 214 are designed to provide a way to measure the electrical potential across a metal casing for the SFF module. The base 208 can also include additional electrical circuitry that can be useful in the testing process. Alternately, spring contacts and/or additional electrical circuitry can be part of PCB 250 that is attached to top portion 204.

The PCB 250 can include a temperature sensor 252 and additional testing circuitry 259. In this embodiment, temperature sensor 252 is specifically positioned such that it can contact a top portion of the case of the SFF module at an appropriate temperature measuring point. The additional testing circuitry 259 can include one or more electrical pads 258 which are positioned such that pins 228 in base 202 can form an electrical connection with PCB 250 when top 204 is lowered onto an SFF module to be tested.

Embodiments of the present invention provide several advantages over testing mechanisms in the prior art. While the basic design remains the same, various embodiments of the invention can be used to test many different kinds of modules. The design facilitates the easy interchange of one module with another, thus making the testing process for many modules much more efficient. The use of a TEC and temperature sensors allows for the rapid testing of the module over a range of temperatures. This temperature cycle testing is much more efficient that using, for example, the prior art oven. The modules can be rapidly heated or cooled to any desired temperature for testing purposes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A test apparatus comprising:
a fixed first portion; and
a second portion connectable to said first portion, said second portion having at least one testing device that can be used to test an optoelectronic module disposed between said first portion and said second portion; wherein said at least one testing device can be electrically connected to an electrical circuit that is external to the apparatus.

2. The test apparatus of claim 1, wherein said at least one testing device is a printed circuit board that is electrically connected to said external electrical circuit.

3. The test apparatus of claim 1, wherein said at least one testing device is chosen from a group consisting of a temperature sensor, a short circuit test contact, and a thermoelectric cooler.

4. The test apparatus of claim 1, wherein said optoelectronic module is any one of a SFF module, a SFP module, a XFP module, and a GBIC module.

5. The test apparatus of claim 1, wherein said first portion is mounted on a printed circuit board.

6. The test apparatus of claim 5, wherein said device is electrically connected to said printed circuit board during a testing operation.

7. The test apparatus of claim 1, further comprising at least one test probe capable of testing at least one component of said module.

8. A system for testing an optoelectronic module, the system comprising:
a printed circuit board (PCB);
a first portion attached to said PCB;
a second portion attached to said first portion, said second portion having at least one testing device that can be used to test an optoelectronic module disposed between said first portion and said second portion;
wherein the optoelectronic module can be electrically and mechanically connected to at least one of said PCB and said first portion and wherein said at least one testing device can be electrically connected to an electrical circuit that is external to the apparatus.

9. The system of claim 8, wherein said at least one testing device is a second printed circuit board that is electrically connected to said external electrical circuit.

10. The system of claim 8, wherein said at least one testing device is chosen from a group consisting of a temperature sensor, a short circuit test contact, and a thermoelectric cooler.

11. The system of claim 8, wherein said optoelectronic module is any one of a SFF module, a SFP module, a XFP module, and a GBIC module.

12. The system of claim 8, wherein said at least one testing device is electrically connected to said PCB during a testing operation.

13. The system of claim 8, further comprising at least one test probe capable of testing at least one component of said module.

14. A method for testing an optoelectronic module, the method comprising:
providing a test apparatus comprising a printed circuit board (PCB), a first portion attached to said PCB, a second portion attached to said first portion, said second portion having at least one testing device that can be electrically connected to an electrical circuit that is external to said test apparatus;
connecting the optoelectronic module to said test apparatus; and
performing one or more tests on the optoelectronic module.

15. The method of claim 14, wherein said PCB is specifically designed to test one of a SFF module, a SFP module, a XFP module, and a GBIC module.

16. The method of claim 14, wherein said at least one testing device is specifically designed to test one of a SFF module, a SFP module, a XFP module, and a GBIC module.

17. The method of claim 14, wherein said testing device comprises a thermal electric cooler (TEC), and wherein said performing step includes using said TEC to test the optoelectronic module over a range of temperatures.

18. The method of claim 14, wherein said testing device comprises a temperature sensor that can record a temperature of the module during the performing step.

19. The method of claim 14, wherein said testing device comprises a pair of short circuit test contacts in electrical contact with a casing of the optoelectronic module, and wherein said performing step includes verifying that there are no electrical shorts between an internal component of the module and said casing.

20. The method of claim 14, wherein said testing device further comprises using at least one test probe capable of testing at least one component of said module, and wherein said performing step includes using said at least one test probe to test said at least one component.
